(19) United States
(12) Patent Application Publication
(10) Pub. No.: US 2014/0237256 A1
(43) Pub. Date: Aug. 21, 2014

(54) METHOD FOR SECURING DATA USING A DISPOSABLE PRIVATE KEY

(71) Applicant: Mourad Ben Ayed, Cupertino, CA (US)

(72) Inventor: Mourad Ben Ayed, Cupertino, CA (US)

(21) Appl. No.: 13/769,351

(22) Filed: Feb. 17, 2013

(51) Int. Cl. H04L 9/08

(52) U.S. Cl. CPC H04L 9/08
USPC 713/186

(57) ABSTRACT

A method for securing data uses a unitary device to obtain a biometric reading from a user, and to generate a new key pair corresponding to the user's biometrics. The unitary device uses a private key from the key pair to encrypt data or voice, sends the encrypted data or voice to a second device and deletes the private key. The unitary device can authenticate the user using a previously generated public key corresponding to the user's biometrics. Also, the second device can decrypt the received data or voice using a public key corresponding to the user and previously received from the unitary device.

### FIELD OF THE INVENTION

The present invention relates to public key cryptosystems, and more particularly, to a public key infrastructure employing disposable short-term certificates for authentication and/or authorization.

### BACKGROUND

As more and more information is moving into electronic form, encryption is becoming more common. One prior art method of encryption is public key encryption—an encryption scheme in which each person gets a pair of keys, called the public key and the private key. Each person's public key is published while the private key is kept secret. Messages are encrypted using the intended recipient's public key and can only be decrypted using the recipient's private key. Messages are signed using the sender's public key and can only be decrypted using the sender's public key. The need for sender and receiver to share secret information (keys) via some secure channel is eliminated—all communications involve only public keys, and no private key needs to be transmitted or shared. Public-key cryptography can be used for authentication (digital signatures) as well as for privacy (encryption). Other encryption schemes, such as symmetric key encryption rely on an exchange of keys.

Public-key cryptography has traditionally been used to ensure the integrity of data. Used properly however, encryption may also be used to identify the source of the data. This is clearly important even when the data itself is not private. Thus, public-key cryptography may serve as a technique for authenticating the data by verifying that the data came from a source specifically identified by the private-key. In this regard, the data is said to be signed, that is, affixed with a digital signature created only by the holder of a private key. Anyone who knows the corresponding public key can verify the digital signature. This assures that the data did in fact come from the person who holds the private key, and that the data has not been altered.

To create a digital signature for data, the sender first applies a cryptographic hash function to the data. This hash function accepts any amount of input data, and produces a fixed-size output, typically between 64 and 256 bits (20 to 80 decimal digits). The hash function has two important properties. First, if any portion of the input data is changed even slightly, the output has a value which will be completely different. Second, it is very difficult to find or construct input data that will produce a given desired hash output.

The hash value is then encrypted, using the sender's private key. The data and the encrypted hash function are sent to a receiver. The receiver first computes his own hash value based on the data portion of the received message. The receiver also decodes the encrypted hash value using the sender's public key. If the two hash values match, the receiver knows that the message must have come from the holder of the public key. The receiver knows that the message came from the holder of the public key because the encrypted hash value was decoded with the sender's public key. Only the sender's private key could have done this encryption in the first place. Accordingly, since the private portion of the key pair is assumed to be held secret by the key holder, no one else could have performed the encryption. The receiver also knows that the data portion has not been changed since the sender signed it because the received encrypted hash value matches the value the receiver computed himself or herself. The encrypted hash value was computed at the time of the message signature. Any change in the data would have drastically changed the hash value. Accordingly, the encrypted value sent with the message would not match the value the receiver computes. Although a digital signature assures the integrity of the data, it does not assure the identity of the sender. The receiver knows only that the data was signed by the holder of the private key, but they cannot be assured that any particular person is the holder of that key. Anyone could have generated a key pair, and attached the name of some other party to that key pair. This inability to reliably associate a real human being with a key pair is known as “the trust problem”.

Various encryption programs are known to exist. One such system is known as PGP (for “Pretty Good Privacy”) from Network Associates, Inc. PGP is primarily used to encrypt e-mail messages, but any other type of data may be encrypted. PGP can also apply digital signatures to data, and it can both sign and encrypt the same data. To sign or verify a message, PGP uses a single, large size key pair, such as one having a default value of 2,048 bits or longer. This makes it infeasible for an adversary to happen upon the right value of a PGP key pair by simply guessing. However, the large size of PGP keys means that PGP takes significant computer time to create or verify a digital signature.

Another encryption system involves SSL3 (for “Secure Sockets Layer 3”). SSL3 is a protocol often used in web browsers to provide confidentiality. SSL3 may also be used to provide authentication services. For instance, when a connection is established, either side in an SSL3 exchange can request that the other side identity itself by means of a public-key certificate. SSL3 does not explicitly cite the size of the key used, but in practice, all key pairs are relatively long. The shortest known implementation uses a minimum key length of 512 bits (160 decimal digits). The cryptographic community does not consider this size long enough to be secure against a determined adversary. Unfortunately, SSL3 requires a negotiation between the server and the client at the beginning of the communication. So, even if confidentially is not desired, the client must tell the server what cryptographic services it wants, which makes the protocol unsuitable for use in a real-time environment where there may be multiple recipients. Further, the protocol negotiation at the beginning prevents anyone from joining an already established communication.

Another encryption system is known as IPSEC, for Internet Protocol Security. IPSEC is a relatively new standard and will be included as part of the next version of TCP/IP called Ipv6. IPSEC provides confidentiality and keeps eavesdroppers from listening to messages. IPSEC operates at the IP layer (OSI layer 3), such that when data passes through several routers on its way to the destination, IPSEC decodes and re-encodes the data en-route. Clearly, this could be time-consuming and require a significant amount of computer time to accomplish successfully.

U.S. Pat. No. 8,260,262 by the current inventor titled “System for three factor authentication challenge” teaches issuing a challenge question to the user, and capturing the user's biometric response using a short wireless device. Although this method teaches biometric challenge, it does not teach generating and using a disposable private key. Furthermore, it does not teach using PKI for signing.

U.S. patent application Ser. No. 13,475,974 by the current inventor titled “System for digital signing” discloses a method and apparatus for digitally signing a document using a short wireless device holding a private key. The short wireless device can also hold biometric information for authenticating the user. Although this method uses a mobile device for encryption, it does not teach generating and using a disposable private key. Furthermore, it does not teach using PKI for validating the user onboard the mobile device. It also does not teach digital signing with non-repudiation.

US Patent application #2009/0044019 by Lee et al. titled “System and method for digitally signing electronic documents” teaches a system for digital signing including a mobile device. A digest encrypting module encrypts the digest, generates an encrypted value, and sends the encrypted value to an application server. A merging module merges the encrypted value and the original electronic document. Although this method uses a mobile device for encryption, it does not teach generating and using a disposable private key. Furthermore, it does not teach using PKI for validating the user onboard the mobile device.

U.S. Pat. No. 7,698,565 by Bjorn et al. titled “Crypto-proxy server and method of using the same” discloses a method of providing a certificate from a client to a server. The method comprises receiving a request for a certificate from the server and forwarding the request to a biometric certification server (BCS). The method further includes receiving a biometric identification from the client and forwarding the biometric identification to the BCS. If the biometric identification matches a registered user on the BCS, receiving a certificate including a public key of the client certified by the BCS, and forwarding the certificate to the server, thereby identifying the client to the server. Although this method uses a disposable private key, this method does not use a unitary device for generating the disposable public key, involves multiple servers and does not work off-line. It also does not teach digital signing with non-repudiation.

U.S. Pat. No. 6,763,459 by Corella titled “Light weight public key infrastructure employing disposable certificates” teaches a PKI includes an off-line registration authority that issues a first unsigned certificate to a subject that binds a public key of the subject to long-term identification information related to the subject and maintains a certificate database of unsigned certificates in which it stores the first unsigned certificate. An on-line credentials server issues a short-term disposable certificate to the subject that binds the public key of the subject from the first unsigned certificate to the long-term identification information related to the subject from the first unsigned certificate. The credentials server maintains a table that contains entries corresponding to valid unsigned certificates stored in the certificate database. The subject presents the short-term disposable certificate to a verifier for authentication and demonstrates that the subject has knowledge of a private key corresponding to the public key in the short-term disposable certificate. Although this method uses a disposable private key, this method does not use a unitary device for generating the disposable public key, involves multiple servers and does not work off-line. It also does not teach digital signing with non-repudiation.

Although a digital signature assures the integrity of the data, it does not assure the identity of the sender. The receiver knows only that the data was signed by the holder of the private key, but they cannot be assured that any particular person is the holder of that key. Anyone could have generated a key pair, and attached the name of some other party to that key pair. This inability to reliably associate a real human being with a key pair is known as “the trust problem”. Thus, a need exists for systems for providing convenient digital encryption/signing using a unitary device and disposable private keys and that ensures non-repudiation. The protocol must be suitable for use in a real-time environment, multiple recipients environment and off-line.

### SUMMARY OF THE INVENTION

The method for real-time data authentication of the present invention overcomes the limitations of the prior art discussed above.

A method for securing data using a disposable private key comprising:

issue at least one first question; obtain at least one biometric response corresponding to said at least one first question using at least one biometric input means; perform an action selected from the group consisting of: encrypt digital data using the at least one private key, decrypt digital data using the at least one private key, authenticate the at least one private key using a previously generated public key corresponding to the at least one first question; delete the at least one private key.

A method for securing data using a disposable private key comprising:

obtain at least one biometric sample from a user using at least one biometric input means; generate at least one private key corresponding to said at least one biometric sample using a processor; use the at least one private key to perform an action selected from the group consisting of: encrypt digital data, decrypt digital data, authenticate the at least one private key using a public key; delete the at least one private key.

A method for securing data using a disposable private key comprising:

obtain at least one biometric sample from a user; generate at least one private key corresponding to said at least one biometric sample; perform an action selected from the group consisting of: decrypt a digital data stream using the at least one private key, encrypt a digital data stream using the at least one private key; delete the at least one private key.

### BRIEF DESCRIPTION OF THE FIGURES

The present inventions may be more clearly understood by referring to the following figures and further details of the inventions that follow.

FIG. 1 is a flowchart illustrating the method for encryption using disposable private keys.

FIG. 2 is a flowchart illustrating publishing the public key.

FIG. 3 is a flowchart illustrating decrypting encrypted data.

FIG. 4 is a flowchart illustrating authenticating the user.

FIG. 5 is a flowchart illustrating authenticating the user using proximity.

FIG. 6 is a flowchart illustrating authenticating the user using geo-location and/or motion.

FIG. 7 is a flowchart illustrating a voice bridge using disposable private keys.

Similar reference numerals are used in different figures to denote similar components.

### FURTHER DETAILS OF THE INVENTIONS

The present invention is directed to using a wireless device (e.g. a Bluetooth token, Bluetooth watch, Bluetooth badge, NFC token, a mobile phone), to sign a transactions with a key pair/private key/public key derived from a voice sample. The same key pair/private key/public key is generated from the same voice sample. Also, different voice samples corresponding to different challenge questions can be collected and used to derive the signing key pair/private key/public key.

The present invention is directed to a method for encrypting or authenticating data in real-time. It utilizes disposable private keys derived from biometric readings, device identifiers, and other certificates. The present invention ensures real-time operation, off-line operation and is capable of cycling private keys. The present invention also ensures non-repudiation and this information serves as a mark of authenticity assuring a recipient that the data did in fact originate from an indicated source and from a specific user. The present invention works with any type of digital data to be transmitted, for example, digital video or digital audio. In addition, the method for real time data encryption or authentication may be utilized in conjunction with any type of transmission medium, for example, land line or wireless.

A sender desires to transmit data and wants the receiver to be able to authenticate or decrypt the data in real-time. The sender publishes a public key or certificate in any number of ways and methods directly or through a certificate authority.

This invention uses a disposable private key that is derived from the sender's biometrics to ensure non-repudiation, that is the sender and only the sender can re-generate and use the private key for encryption. For this, a user device captures the user biometric readings, for example voice, generates features of the user voice, then uses the features to generate a score, and use the score to generate a private key.

In a preferred embodiment, the score is a weighted average of several features of the voice or biometrics such as Energy level of a section, the zero-crossings within the section or coefficients of Linear Predictive Coding (LPC), The Cepstral coefficients, etc. A section is a section of voice generally delimited by silence. Time warping can be used to stretch the sections to equal sizes before calculating the features.

Dynamic time warping is alignment is used to line up sections of the speech signal and ensure that the averages are calculated over corresponding sections.

The score is used to generate a key pair. These operations can be performed in real-time using software, DSPs, specialized chipsets or other programmable logic chipsets. Also, since the key pair is generated without the help of a remote device, the system can work off-line. The system can also be used for voice encryption over telephone lines without help of any internet connected server or network connected server.

The disposable private key ensures that the private key cannot fall in the wrong hands, and ensures that the sender is trusted. This in turn removes the need for a certification authority. It also removes the need for revocation or certification timeout.

The sender can simply distribute public keys to correspondents that can un-sign data from the sender, or sign data to be un-signed by the sender. If the sender is compromised, the sender can generate another key pair, and can publish the new public key. For example, the sender can use a new “vocal phrase” to generate a new key pair.

It is noted that voice is the best biometric method for this signing method due to unlimited set of phrases that the sender can use for generating a private key. Alternatively, the sender can change the phrase any time and publish new public keys. Alternative biometric methods are finger prints and motion signing.

In an alternative embodiment, an algorithm generates the same key pair given a set of biometric features and other inputs.

In an alternative embodiment, an algorithm generates the same key pair given a set of biometric features and other inputs while allowing for some variance in the features or score.

For example, one such algorithm can take a range of scores and assign them to one value (n) in that range in order to get rid of variability in the score. The algorithm can take the new value (n), extrapolate it, and use it to get to a prime number corresponding to the new value (n).

It is noted that the user can constitute a set of phrases for challenge authentication using voice response, can generate public keys corresponding to the challenge questions, and publish the public keys to correspondents. Challenge/response biometrics can be used to guarantee non-repudiation as it is immune to replay attacks. For example, a user is asked a number of personal questions, and his/her voice responses are stored, and the corresponding public keys generated and distributed. In this embodiment, the user is asked a random challenge question from a set of questions, and must provide a correct response to the asked challenge question. The correct response is used to generate a private key and that is authenticated by a resident public key that corresponds to the asked challenge question. The receiver can have multiple public keys to decrypt the user's encrypted messages and can try them blindly until one of them works. Alternatively, the sender can send a code indicating a specific public key that must be used for decryption, and in this case, the receiver must use a specific public key for decryption.

In another alternative, a second private key is generated from the user biometrics and is used to encrypt or decrypt data. The second private key can also be deleted after being used.

Alternatively, the sender can use a specific public key for encryption corresponding to a specific user and a specific challenge question/challenge question code, and can send an indication of the challenge question to the specific user. The user must respond to the challenge question in order to generate the corresponding private key, and in order to decrypt the message using the generated private key.

Alternatively, a program onboard the sender's device periodically captures samples of the user's speech, uses them to generate new key pairs (rotating key pairs or rotating private keys), deletes old keys, and encrypts data using the new keys. The receiver can be instructed to use different corresponding keys for decryption.

It is important to note that according to the present invention, the data can be encrypted; also, the hash value of the data can be encrypted.

If the hash is encrypted, the data is not concealed or corrupted in any way. Even if a receiver were not able to authenticate the data, the receiver would still be able to view and utilize the data if he/she so desires. Essentially, as each unit of signed data is received, the receiver strips off the digital signature for authentication and utilizes the data. If the data is encrypted, the data may not be read or utilized without knowledge of the public keys or keys transmitted with the certificates.

In an embodiment, the current invention uses a smart phone to provide digital signing and encryption. The smart phones uses onboard biometric reader means such as a microphone, accelerometer, gyro, scanner . . . to obtain biometric readings. The smart phone may use onboard Secure Element to store public and/or private keys. Authentication operations, digital signature operations, and encryption operations may be performed on the mobile device. The mobile device can generate key pairs based on a combination of biometric, device and/or user information. Also, the same key pair is generated from the same combination of biometric (with predefined variance), device and/or user information.

A newly generated private key (generated using a biometrics sample) can be authenticated using a previously stored public key.

In another embodiment, the current invention uses features of short wireless transceivers (such as BLUETOOTH) to provide digital signing and encryption using a wireless token. The wireless token can be a mobile phone. In another embodiment, the wireless token does not have a cellular transceiver. The wireless token also can provide onboard biometric reader means such as a microphone, accelerometer, gyro, tilt sensor, motion sensor, scanner . . . to obtain biometric readings. The token can use a Secure Element to store public keys. The token can provide an alarm when it is away from the user's terminal by 1 meter, 10 meter or 30 meters. The wireless token generates a feature set corresponding to the biometric readings.

Motion sensor can be used to detect if the user is in motion or idle, and to authorize or deny response depending on if the user is in motion or idle. This is used to reduce a security hack attack “Relay Attack” that is known in keyless entry systems used by car manufacturers. Most keyless entry systems today respond upon receiving a request. This feature is exploited by hackers in order to hack the system. It has been noted that when a user is asking for access to a door, car, Facebook, . . . the user has to stop moving. For that reason, a motion sensor is used to deny responses when the user is not idle and to respond when the user is idle.

For example, while the user is walking next to his car, System for digital signing will not respond to any wireless message. If System for digital signing receives a valid message while the user is not moving, it will respond.

Motion sensors can also be used to reduce false alarms. For example, if the system for digital signing detects a signal loss while it is not moving, the security threat is lower, and the alert can be different from then the system is moving. The case where motion is not detected generally corresponds to the user staying at home, office or coffee shop . . . , and leaving system for digital signing on a table while the mobile phone leaves proximity. On the other hand, when System for digital signing is moving and a signal loss occurs, this case often corresponds to the user leaving the mobile device behind, and thus the security risk is much higher.

It is understood that motion sensor is optional and is not necessary for the core operation of system for digital signing.

The current method may use a crypto module for encryption. The crypto module or crypto center includes authentication, hashing, encryption, AES256, SHA256, Apple Authentication chipset (for communicating with iOS devices) and Secure Element chipsets. It encrypts information and stores it. We can use symmetric encryption such as Advanced Encryption Standard (AES) (AES-128, AES-192 and AES-256), Triple DES (3DES) or asymmetric encryption such as RSA (Rivest, Shamir and Adleman), in this embodiment, the system for digital signing and PED use a cryptographic hash function such as SHA-0, SHA-1, SHA-2, MD5 or other hash functions to authenticate each other, prior to the system for digital signing sending the one or more keys in encrypted form.

In a preferred embodiment, Crypto center comprises an inalterable memory or Secure Element in which the user keys, private keys, certificates, public keys or combination thereof are recorded and that guarantees inviolability of the data.

An external certification authority can guarantee that the public key belongs to the operator by means of a certificate.

In an alternative embodiment, the user key can be a private key, a part of a private key, an encrypted private key, an encrypted part of a private key, a public key, a part of a public key, an encrypted public key, an encrypted part of a public key, a certificate. In an alternative embodiment, the system for digital signing uses a user secret code (such as a PIN code) and a stored user key to obtain a user private key.

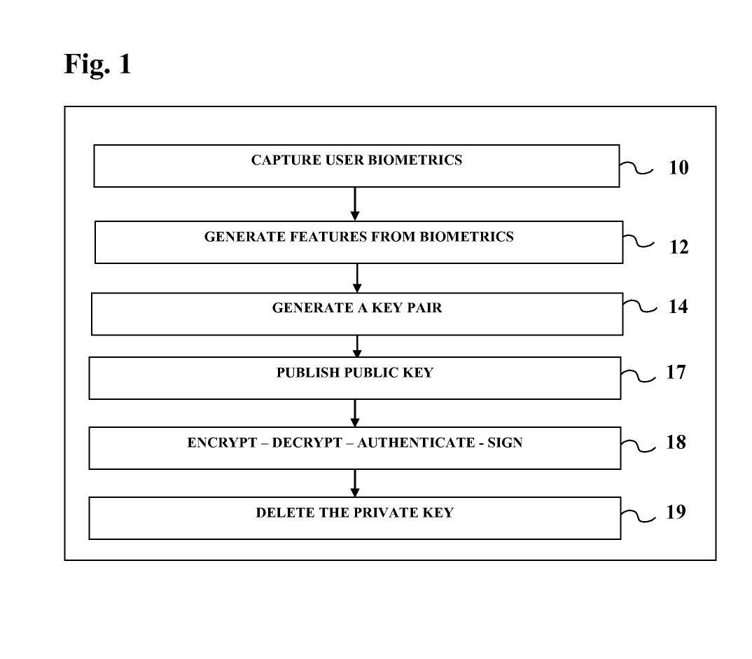

Referring to FIG. 1, the flowchart illustrates a method for encryption using a disposable private key. In step 10, the user biometrics are captured using an onboard reader such as a microphone, a finger print scanner, a vein scanner, an iris scanner, a motion detector, etc. In step 12, an onboard processor generates a set of features from the biometrics. The set of features identify the user and differentiates him from other users. It is noted that the system is locked to the user device, and thus, it is only available to a limited set of potential intruders. For example, the method uses a combination of device ID and biometric features.

In step 14, the processor generates a key pair using the set of features such as user voice response to a challenge question and other information such as Bluetooth ID/MAC/Phone number of the user device.

In step 17, the user publishes the public key to correspondents.

In step 18, the processor uses the private key to encrypts data and send encrypted data to correspondents, decrypt data from correspondents, authenticate the user to correspondents, sign a digest and send it to correspondents.

In an alternative embodiment, the processor receives a message (such as a random number) from a correspondent, combines the message with data to be sent, signs/encrypts the combined message and send it to correspondents.

In another alternative embodiment, the processor receives a message comprising a code for an obfuscation function from a correspondent, uses a function corresponding to the code for an obfuscation function to obfuscate data, signs/encrypts the data and sends it to correspondents.

In step 19, the processor deletes the private key.

In another embodiment, the processor deletes the generated at least one private key after an event selected from the group consisting of: a timeout period is reached, a user session is terminated, traffic is not detected for a period of time, user is silent for a period of time, a second device went out of a predetermined Bluetooth proximity distance, generally 1 m, 3 m, 10 m, 15 m, 20 m, 25 m or 30 m.

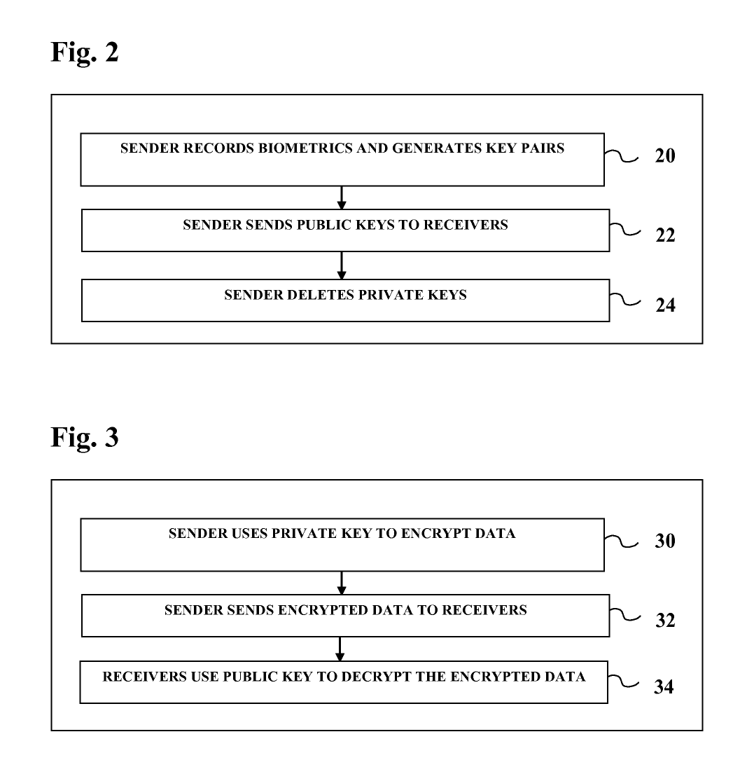

Referring to FIG. 2, the flowchart illustrates publishing the public key. In step 20, a sender device records the user biometrics and generates key pairs. In step 22, the sender device sends public keys to correspondents. In step 24, the sender deletes the private keys.

In another preferred embodiment, the sender device also sends a time stamp, current GPS location information, user biometrics.

Referring to FIG. 3, the flowchart illustrates decrypting encrypted data. In step 30, a sender device uses a private key to encrypt data. In step 32, the sender device sends encrypted data to receivers. In step 34, receivers use a previously received public key to decrypt the encrypted data.

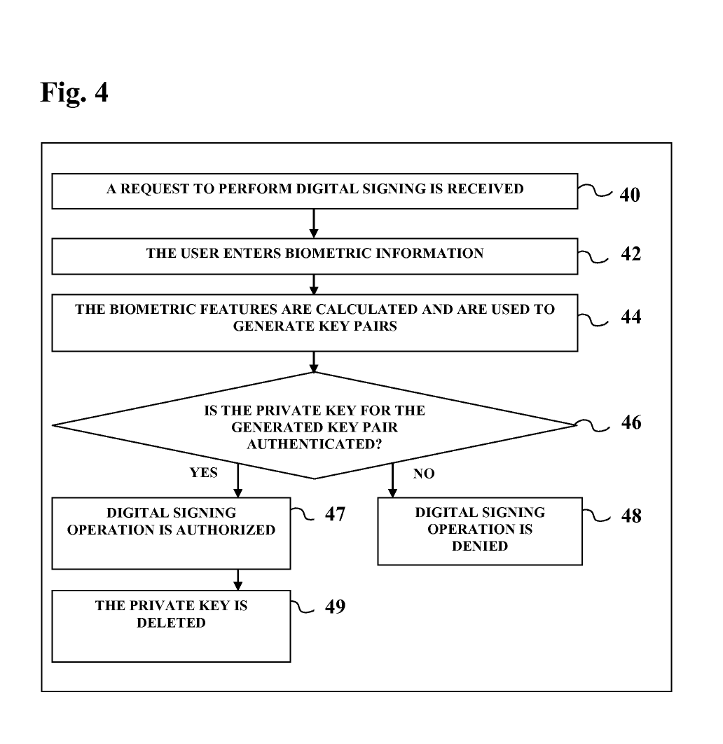

Referring to FIG. 4, the flowchart illustrates authenticating the user. In step 40, the user makes a request to perform signing. In step 42, the user enters biometric information. In an alternative embodiment, the user is requested to answer and random challenge question that is different from a previously asked question. In step 44, a processor calculates features from the biometric samples and uses them to generate key pairs. In a preferred embodiment, the processor uses the biometric features set together with other identifiers such as device ID, Bluetooth ID, MAC ID, certificates . . . to generate key pairs. In step 46, the generated private key is checked against a stored public key for authentication. In step 48, if the private key does not match the previously generated public key, the digital signing operation is aborted. In step 47, if the private key matches the public key, the signing operation is authorized. In step 49, after signing is completed, the private key is deleted.

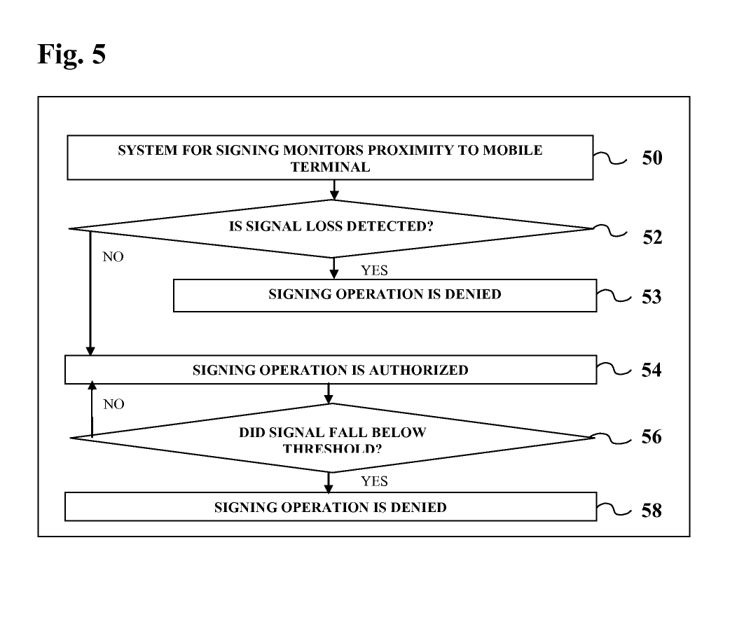

Referring to FIG. 5, the flowchart illustrates authenticating the user using proximity. In step 50, a user signing device monitors proximity to a mobile terminal. In step 52, if a loss of signal is detected, the signing operation is denied in step 53. Otherwise, in step 54, the signing operation is authorized. In step 56, if the signal falls below a threshold, the signing operation is denied in step 58.

After the user is authenticated, if a Bluetooth signal drops below a threshold, or signal loss is detected, the user application may issue warnings to the user, may close any open document, may encrypt any decrypted file, may disconnect, and may issue visual, audible and motion alerts.

If the user is not logged in to an application onboard a mobile device or tablet, system for digital signing may connect to the mobile device or tablet as a headset profile or hands free profile. That way, on detection of a loss of link, an alert is issued to the user. After the user is logged in to an application onboard a mobile device or tablet, if the user tries to access the application after being idle for a period of time, if a disconnect occurred during this period of time, the user is required to authenticate. If the idle period has exceeded a threshold, the user is asked to authenticate.

On connection drop, the system for digital signing may attempt to reconnect and can issue an intelligent alarm, issue a visual or vibration indication. Furthermore, the application or device may logout the user, may lock, block access, shut down, encrypt data, logout, request biometric authentication, issue alarm, report the event to a remote server, send an alert message, or issue an alarm. Furthermore, the application or device may refuse to perform digital signing operation.

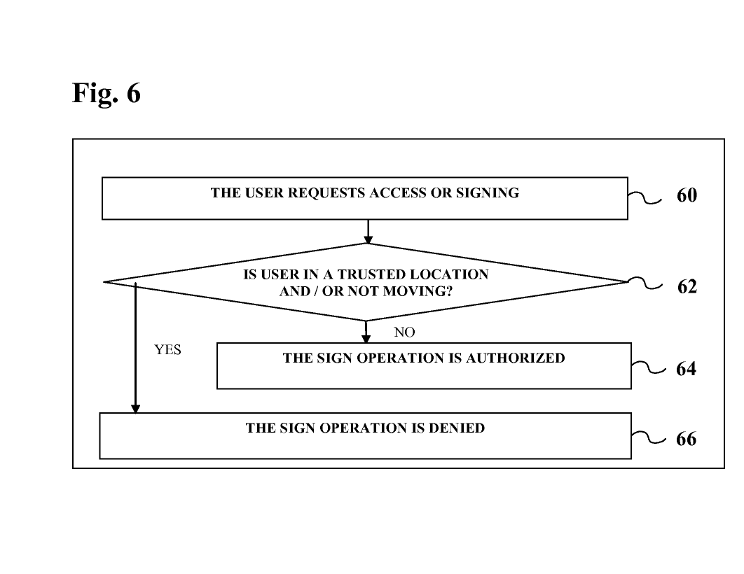

Referring to FIG. 6, the flowchart illustrates authenticating the user using geo-location and/or motion. In step 60, a user requests access or signing. In step 62, if the user is in a trusted location and/or is not moving the signing operation is authorized in step 64, otherwise, in step 66, the singing operation is denied and/or the private key is deleted/removed/overwritten.

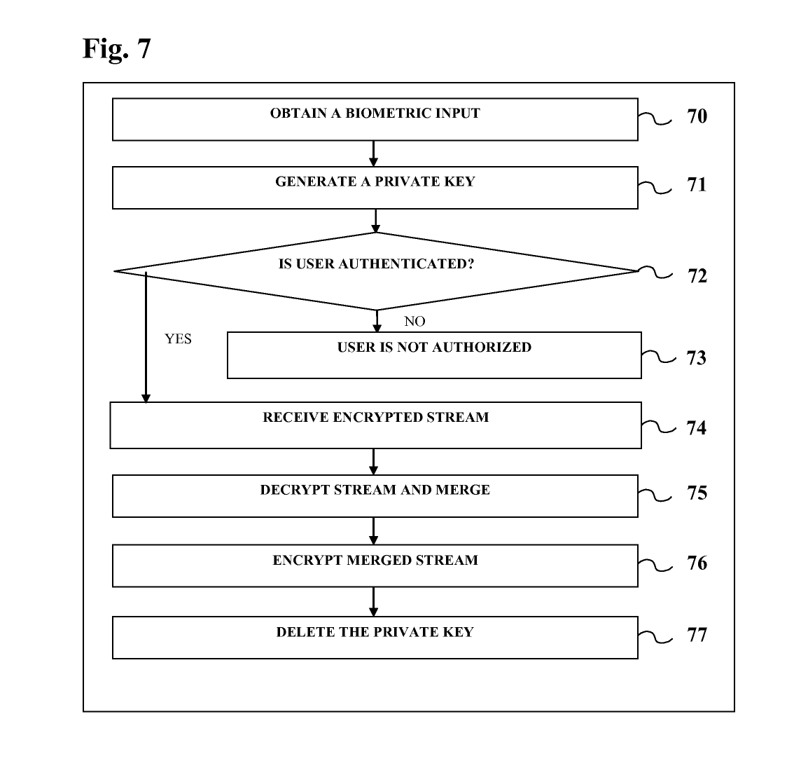

Referring to FIG. 7, the flowchart illustrates a voice bridge using disposable private keys. In step 70, a system gets biometric information from a user or a set of features or a score of a set of features. In step 71, the system generates a key pair, and obtains a private key. In step 72, the system can validate the user using a previously stored public key, and if the generated private key does not match the stored public key, the user is not authorized in step 73. If a match is found, the system receives encrypted streams in step 74, decrypts them in step 75 and merges them. The system can use the generated private key for decryption. Alternatively, the system can use public keys corresponding to each stream for decryption. In step 76, the system encrypts the merged stream. The system can use the generated private key for encryption. Alternatively, the system can use a public key corresponding to the destination for encryption. In step 77, the system deleted the generated private key. a user requests access or signing.

In another embodiment, the user's mobile device scans the input from the microphone in real-time to detect a previously known phrase or word, for example “hello”, or “I am” . . . . It generates scores corresponding to the user's pitch, length of time, Energy level of a section, the zero-crossings within the section or coefficients of Linear Predictive Coding (LPC), The Cepstral coefficients, etc. for the captured word of phrase. It generates at least one score, and compares it to at least one known score. For example, if the processor detects/captures “I am”, it generates scores for the captured sample, and compares them to previously stored scores for “I am”.

The system for digital signing can be connect to a computer using a port and user data can be flashed to system or written to memory (RAM or flash) onboard system. User data can be password, private keys, public keys, authentication parameter, personal info, biometric info, OTP seed, configuration parameters, operation hours, operation days, buzzer type, buzzer volume, buzzer duration, and alarm type. Those parameters can be flashed on system for digital signing by connecting it to another programming device (e.g. programmer, vehicle computer). Those parameters can also be transferred wirelessly and stored.

System for digital signing may have a foldable or slide able earpiece. The earpiece can be used as a BLUETOOTH headset. Also, voice from an onboard earpiece or speaker can be encrypted and voice from microphone encrypted onboard System for digital signing.

The system for digital signing is designed so that it does not allow reset, and it does not go to discoverable mode unless it is updated through an authorized update application. The system for digital signing pairs with a second apparatus. Once paired to a predefined number of devices, it becomes undiscoverable or invisible to any other device except second apparatus and will not respond to any request from any device except second apparatus. It can establish secure two-way wireless connection with a second apparatus.

A significant benefit of this system is the ability to monitor a connection while keeping power consumption to a very low level. This enables one of ordinary skill in the art to build portable devices in accordance with the present inventions that use small batteries (100-200 mAh), which can last for at least 2 or 3 weeks before being recharged or swapped.

System for digital signing may have a sleep mode and when in sleep mode, battery consumption is below 1 mA. System for digital signing consumption is generally below 40 mA. Its size is below 10 cubic centimeters, and it weighs less than 25 grams. In a preferred embodiment, system for digital signing has a size equal to or smaller than 5 cm×3 cm×1.5 cm or 22.5 cubic centimeters (“cc”) and is less than 50 g in weight. In an embodiment, there are no manually operated controls (e.g., off-on or activation button is magnetically operated, so the housing is not provided with button or switch access), and the device may not have a display.

The details of certain embodiments of the present inventions have been described, which are provided as illustrative examples so as to enable those of ordinary skill in the art to practice the inventions. The summary, figures, abstract and further details provided are not meant to limit the scope of the present inventions, but to be exemplary. Where certain elements of the present inventions can be partially or fully implemented using known components, only those portions of such known components that are necessary for an understanding of the present invention are described, and detailed descriptions of other portions of such known components are omitted so as to avoid obscuring the invention. Further, the present invention encompasses present and future known equivalents to the components referred to herein.

The inventions are capable of other embodiments and of being practiced and carried out in various ways, and as such, those skilled in the art will appreciate that the conception upon which this disclosure is based may readily be utilized as a basis for the designing of other methods and systems for carrying out the several purposes of the present inventions. Therefore, the claims should be regarded as including all equivalent constructions insofar as they do not depart from the spirit and scope of the present invention. The following claims are a part of the detailed description of the invention and should be treated as being included in this specification.

1. A unitary apparatus acting as a Bluetooth headset or hands-free profile device and used to encrypt communication, comprising:
at least one voice input means located onboard the unitary apparatus to obtain at least one biometric input;
a processor located onboard the unitary apparatus to generate at least one key corresponding to at least one spoken word or phrase,
whereby the processor located onboard the unitary apparatus connects wirelessly to a mobile device using Bluetooth headset or hands-free profile,
and whereby the processor located onboard the unitary apparatus encrypts voice from the at least one voice input means and sends the encrypted voice through the mobile device using Bluetooth headset profile or hands-free profile,
and whereby the processor located onboard the unitary apparatus decrypts encrypted voice received through the mobile device using Bluetooth communication headset profile or hands-free profile,
and whereby the processor located onboard the unitary apparatus scans voice input in order to detects a known word or phrase in the voice;
whereby after the processor located onboard the unitary apparatus detects a first word or a phrase in the voice,
wherein the first word or phrase correspond to at least one first reference word or phrase,
the processor located onboard the unitary apparatus generates at least one second key corresponding to the detected first word or phrase,
the processor located onboard the unitary apparatus validates the at least one second key using at least one reference key corresponding to the at least one first reference word or phrase,
wherein after validation fails, the processor located onboard the unitary apparatus performs an action selected from the group consisting of:
stop encryption and delete the at least one key.

2. (canceled)

3. The unitary apparatus of claim 1 comprising:
encrypting or decrypting data using the at least one key;
whereby after detection of the mobile device going out of a predetermined distance from said unitary apparatus,
the unitary apparatus deletes the at least one key.

4. The unitary apparatus of claim 1 comprising a port means,
wherein said port means can operatively connect to a remote computer,
wherein the remote computer can write at least one configuration data to said unitary apparatus when operatively connected to said apparatus,
wherein the configuration data is selected from the group consisting of:
password, private keys, public keys, authentication parameter, personal info, biometric info, OTP seed, configuration parameters, operation hours, operation days, buzzer type, buzzer volume, buzzer duration, and alarm type.

5. The unitary apparatus of claim 1 comprising:
obtain a second private key;
perform an action selected from the group consisting of:
encrypt digital data using said second private key,
decrypt digital data using said second private key.

6. The unitary apparatus of claim 1 comprising:
a speaker located onboard said unitary apparatus to issue the at least one first question,
a microphone located onboard said unitary apparatus to capture a biometric sample corresponding to the at least one first question.

7. The unitary apparatus of claim 6 not comprising a cellular transceiver.

8. (canceled)

9. A method for encrypted communication between compatible unitary Bluetooth devices using headset or hands-free profile, comprising:
obtaining at least one biometric sample from at least one microphone;
generating at least one key corresponding to at least one spoken word or phrase;
connecting wirelessly to a mobile device using Bluetooth headset or hands-free profile;
encrypting data or voice and sending the encrypted data or voice through the mobile device using Bluetooth headset profile or hands-free profile;
decrypting encrypted data or voice received through the mobile device using Bluetooth communication headset profile or hands-free profile;
scanning voice input in order to detect a known word or a phrase;
whereby after detecting a first word or a phrase in the voice,
wherein the first word or phrase correspond to at least one reference word or phrase,
generating at least one second key corresponding to the detected first word or phrase,
validating the at least one second key using at least one reference key corresponding to the at least one reference word or phrase,
wherein after validation fails, performing an action selected from the group consisting of:
revoke user authorization and delete the at least one key.

10. (canceled)

11. (canceled)

12. (canceled)

13. (canceled)

14. (canceled)

15. The method of claim 9 comprising:
upon detecting that the current unitary device is not in a trusted location, delete the at least one key.

16. (canceled)

17. A method for encrypted communication between compatible unitary Bluetooth devices using headset or hands-free profile, comprising:
generate at least one key;
connect wirelessly to a mobile device using Bluetooth headset or hands-free profile;
use the at least one key to decrypt data or voice received through the mobile device using Bluetooth headset profile or hands-free profile,
use the at least one key to encrypt data or voice and send the encrypted data or voice through the mobile device using Bluetooth headset profile or hands-free profile;
scan input from at least one microphone in real-time to detect at least one known word or phrase,
whereby after detection of a first word or phrase corresponding to a first reference word or phrase,
generate at least one key corresponding to the first word or phrase,
validate the at least one key using at least one reference key corresponding to the reference word or phrase;
wherein after validation fails, perform an action selected from the group consisting of:
stop encryption, stop decryption, delete the at least one key, remove the at least one key, modify the at least one key, over-write the at least one key.

18. (canceled)

19. (canceled)

20. (canceled)
